(19) United States
(12) Patent Application Publication
(10) Pub. No.: US 2025/0001953 A1
(43) Pub. Date: Jan. 2, 2025

(54) SYSTEM, METHOD, AND APPARATUS FOR VIBRATION ISOLATION

(71) Applicant: TuSimple, Inc., San Diego, CA (US)

(72) Inventor: Christopher Luis HERNANDEZ, Tucson, AZ (US)

(21) Appl. No.: 18/444,113

(22) Filed: Feb. 16, 2024

Related U.S. Application Data
(60) Provisional application No. 63/510,500, filed on Jun. 27, 2023.

(51) Int. Cl. B60R 11/02; B60R 11/00

(52) U.S. Cl. CPC B60R 11/0258; B60R 2011/0043

(57) ABSTRACT

Provided herein is a system and method for vibration mitigation at a sensor of a vehicle. Some systems include: at least one sensor; a bracket configured to support the at least one sensor; a sheet metal structure having a first major surface along which the sheet metal structure extends, and a second major surface opposite the first major surface; and a backing plate where the bracket is disposed adjacent to the first major surface of the sheet metal structure, where the backing plate is disposed adjacent to the second major surface of the sheet metal structure, and where two or more fasteners secure the backing plate to the bracket through the sheet metal structure.

### CROSS-REFERENCE TO RELATED APPLICATIONS

This application claims priority to U.S. Provisional Patent Application Ser. No. 63/510,500, filed on Jun. 27, 2023, the contents of which are hereby incorporated by reference in their entirety.

### TECHNOLOGICAL FIELD

An example embodiment of the present disclosure relates generally to vibration isolation for vehicle sensors, and more particularly, to a system, apparatus, and method for mitigating low frequency vibrations for a location sensor of a vehicle.

### BACKGROUND

Autonomous and semi-autonomous vehicle control relies upon accurate digital maps and accurate understanding of the environment of a vehicle. A wide array of sensors are often used for autonomous and semi-autonomous vehicle control. This includes sensors that determine vehicle operating conditions, sensors that establish a location and movement of the vehicle, sensors that determine navigational directions, and sensors that identify the environment around the vehicle.

Maintaining the accuracy and effectiveness of sensors is critical to the proper function of the sensors and to the information that the sensors provide to the vehicle for operation and for autonomous control. Positioning a sensor is not a trivial challenge, as sensors benefit from positioning that specifically suits the type of sensor being oriented. Such sensor positions can be vulnerable to a variety of adverse conditions. For example, sensors positioned outside of a vehicle are vulnerable to environmental conditions and obstacles. Further, sensors experience shock and motion caused by a vehicle traveling within an environment, and the shock and motion can be impacted based on a position of the sensor in or on the vehicle. Still further, vibrations of a vehicle, whether from road surface or from vehicle systems (e.g., engine, suspension, steering, etc.) can adversely impact sensor performance. Beyond positioning of a sensor, maintaining a sensor in good working condition is imperative for proper functionality.

### BRIEF SUMMARY

A system, apparatus, and method are therefore provided for mitigating low frequency vibrations for a location sensor of a vehicle. Embodiments provided herein include a system for vibration mitigation at a sensor including: a bracket configured to support at least one sensor; a sheet metal structure having a first major surface along which the sheet metal structure extends, and a second major surface opposite the first major surface; and a backing plate where the bracket is disposed adjacent to the first major surface of the sheet metal structure, where the backing plate is disposed adjacent to the second major surface of the sheet metal structure, and where two or more fasteners secure the backing plate to the bracket through the sheet metal structure.

According to some embodiments, the at least one sensor is secured to the bracket using at least one fastener. The sheet metal structure of an example embodiment includes a sheet metal component of a vehicle. The at least one sensor of an example embodiment includes a localization sensor. The localization sensor of an example embodiment includes an inertial measurement unit (IMU). According to some embodiments, vibrations experienced by the vehicle are damped by the backing plate before reaching the inertial measurement unit. The backing plate of some embodiments is made of aluminum. The backing plate of an example embodiment is at least ⅛-inch in thickness. The at least one sensor includes, in some embodiments, two localization sensors, where the two localizations sensors include two inertial measurement units. According to some embodiments, the bracket includes a first plate supporting a first of the two inertial measurement units and a second plate supporting a second of the two inertial measurement units. The second plate of an example embodiment is disposed above the first plate relative to the sheet metal structure, and the second plate is supported above the first plate by at least two supports of the bracket.

Embodiments provided herein include a method of mitigating vibration at a sensor including: mounting at least one sensor on a bracket; positioning the bracket on a first side of a sheet metal structure; positioning a backing plate on a second side of the sheet metal structure; and securing the backing plate to the bracket using two or more fasteners through the sheet metal structure to clamp the sheet metal structure between the bracket and the backing plate. The at least one sensor includes, in some embodiments, a first localization sensor and a second localization sensor, where the bracket supports the second localization sensor vertically above the first localization sensor relative to the sheet metal structure.

Embodiments provided herein include a vibration mitigation system for a vehicle including: at least one sensor; a bracket configured to support the at least one sensor; a backing plate; and two or more fasteners, where the bracket is configured to be positioned on a first side of a sheet metal structure of the vehicle, where the backing plate is configured to be positioned on a second side of the sheet metal structure of the vehicle, opposite the first side, and where the two or more fasteners are configured to secure the backing plate to the bracket through the sheet metal structure. The sheet metal structure of the vehicle of some embodiments is a horizontal sheet metal structure. The at least one sensor of some embodiments includes a first localization sensor and a second localization sensor. The bracket of an example embodiment is configured to support the second localization sensor vertically above the first localization sensor. According to some embodiments, the first localization sensor is supported by a first plate, where the second localization sensor is supported by a second plate, and where the second plate is elevated above the first plate by two or more supports. The system of some embodiments includes a noise reducing material positioned between the backing plate and the sheet metal structure. The system of some embodiments includes a noise reducing material positioned between the bracket and the sheet metal structure.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 illustrates a top-view of a vehicle including a localization sensor position according to an example embodiment of the present disclosure;

FIG. 2 illustrates a profile view of the vehicle of FIG. 1 including the localization sensor position according to an example embodiment of the present disclosure;

FIG. 3 illustrates a block diagram of a controller configured to control one or more localization sensors according to an example embodiment of the present disclosure;

FIG. 4 illustrates a pair of localization sensors mounted to a sheet metal structure of a vehicle according to an example embodiment of the present disclosure;

FIG. 5 illustrates a bracket for one or more localization sensors mounted to a sheet metal structure of a vehicle according to an example embodiment of the present disclosure;

FIG. 6 illustrates a pair of localization sensors and a backing plate mounted to a sheet metal structure of a vehicle according to an example embodiment of the present disclosure;

FIG. 7 illustrates a bracket for one or more localization sensors and a backing plate mounted to a sheet metal structure of a vehicle according to an example embodiment of the present disclosure;

FIG. 8 illustrates a pair of localization sensors and a backing plate mounted to a sheet metal structure of a vehicle according to another example embodiment of the present disclosure; and

FIG. 9 illustrates a pair of localization sensors and a pair of backing plates mounted to a sheet metal structure of a vehicle according to another example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

Autonomous vehicle control, as described herein, includes vehicle control that is performed at least partially by a vehicle controller taking some responsibilities away from a human driver. Autonomous vehicle control can include semi-autonomous control, where certain functions are performed by a controller, while a human driver performs other functions, and fully-autonomous control, where a human driver is not necessary for control and navigation of the vehicle. Autonomous vehicle control, as described herein, includes this array of control possibilities such that the term “autonomous vehicle control” can include any degree of autonomous control ranging from minimal autonomy to fully autonomous.

Autonomous vehicle control is becoming more widely adopted, with increasing levels of autonomy becoming practical. Autonomous vehicle control is particularly beneficial for transport of goods, where such transport can occur at all hours of the day and for long distances. Although the systems and methods of example embodiments may be employed in conjunction with a variety of different types of autonomous vehicles, the systems and methods described herein will be described in conjunction with a truck, such as a tractor trailer, that is configured to operate autonomously by way of example, but not of limitation.

Vehicle sensors are often critical for operation of the vehicle. The sensors of conventional, manually-driven vehicles perform a wide range of functions, from wheel speed sensors, to rain detecting sensors, to parking sensors. Vehicles that have some degree of autonomy, whether it is adaptive cruise control, braking assist, steering assist, or total driverless autonomous control, require additional, highly-capable sensors, and many of these sensors are critical to the autonomous functionality of the vehicle. Sensor failures in vehicles or poorly functioning sensors, whether in manually-driven vehicles or autonomous vehicles, can impair vehicle function. When sensors that are critical to autonomous control fail or otherwise perform poorly, such sensor failure or poor performance can require autonomous control to be relinquished to a human driver. Therefore it is critical to maintain vehicle sensor functionality through a wide variety of environmental conditions. While certain sensors can function in a reduced-capacity state, other sensors are more sensitive to environmental conditions and other adverse effects. Embodiments described herein provide a method and system for positioning vehicle sensors in an optimal position for functionality, while also providing a method and system to mitigate vibrations and environmental effects that can adversely impact sensor functionality.

While sensor positioning and functionality is important for all autonomous vehicles, it is particularly important for large vehicles. Roadways with traffic, urban corridors, and narrow streets or rural roads pose a greater challenge to large vehicles as there is less room for error in movement to avoid contact between the large vehicle and any elements of the environment. As such, positioning of certain sensors on a large vehicle is important to optimize functionality.

One such sensor type is a localizing sensor or localization sensor that operates to pinpoint a location of the vehicle. These sensors can be in the form of a Global Navigation Satellite System (GNSS) sensors (e.g., GPS, Galileo, GLONASS, etc.), accelerometers, inertial measurement units (IMU), gyroscopes, magnetic field sensors, etc., or any combination thereof. These sensors rely on obtaining data relating to the vehicle position through detection of signals (e.g., GPS satellite signals) and/or through detecting movement of the vehicle (e.g., IMUs, gyroscopes, etc.). As such, these sensors are sensitive to movement and sensitive to noise in the form of vibrations. Ideally, to maximize efficiency and accuracy, these localizing sensors should be free of vibrations that may be experienced in a vehicle. As these are vehicle-mounted sensors, and as vehicle vibrations including those from the travel surface cannot generally be avoided, vibration mitigation is needed to help dampen vibrations that may be experienced by localizing sensors.

Vibration issues are detrimental to the performance of many types of sensors, and particularly those that include motion sensors such as gyroscopes, accelerometers, and inertial measurement units (IMUs). These types of sensors generate signals based on how they move, and are intended to sense movement within an environment. However, vibrations, which include small movements at certain frequencies can be detected by these sensors, and the vibrations can mask the magnitude and direction of actual motion that should be detected by the motion sensors. Low frequency vibrations, such as those below 100 Hz and particularly those below 50 Hz generally produce larger motions of higher amplitude, which exacerbate the issues caused by vibrations at a motion sensor location. Low frequency vibration mitigation can be challenging, particularly because of the large motion associated with the high amplitudes of low frequency vibrations.

While embodiments described herein focus primarily on localizing or localization sensors and particularly motion sensors, one of ordinary skill in the art will appreciate that the systems described herein can be employed on any sensors, particularly those that suffer from degraded performance when experiencing vibrations. Additional sensors that can benefit from embodiments of the present disclosure include sensors that require line-of-sight as they are particularly sensitive to position and stability since they function best with a clear, broad range of steady vision. Cameras, radar, and light distancing and ranging (LiDAR) are examples of such line-of-sight sensors that benefit from vibration mitigation as described herein.

The vibrations experienced in a vehicle can be caused by a variety of sources. The surfaces over which a vehicle travels can produce vibrations that are experienced within the vehicle. As an extreme example, washboard-type road surfaces produce harsh vibrations within a vehicle even when the vehicle is isolated from the road surface by wheels/tires and suspension components. Other surfaces can produce vibrations within the vehicle, such as concrete which often includes wet weather traction improvement grooves. Concrete is a harder material than asphalt, such that concrete generally results in more road noise and vibration within a vehicle. However, with the addition of weather traction improvement grooves, the noise and vibration can become much greater.

Beyond road noise, vehicles can experience other vibrations. Vehicles that employ internal combustion engines are subject to vibrations produced by those engines. Smaller displacement engines (e.g., 2.0 liters or less) may not produce substantial vibrations; however, larger displacement engines and particularly diesel engines that tend to be found in large trucks can generate substantial vibrations due to the large masses of reciprocating machinery and large combustion chambers. Large diesel engines also tend to idle in the range of 900-1200 revolutions per minute (RPM), producing low frequency vibrations within the vehicle. The large reciprocating masses and large combustion events can produce substantial vibrations that can be transmitted through the vehicle, and potentially amplified by various structures within the vehicle. These vibrations pose problems for various systems of a vehicle, including the sensors as detailed above.

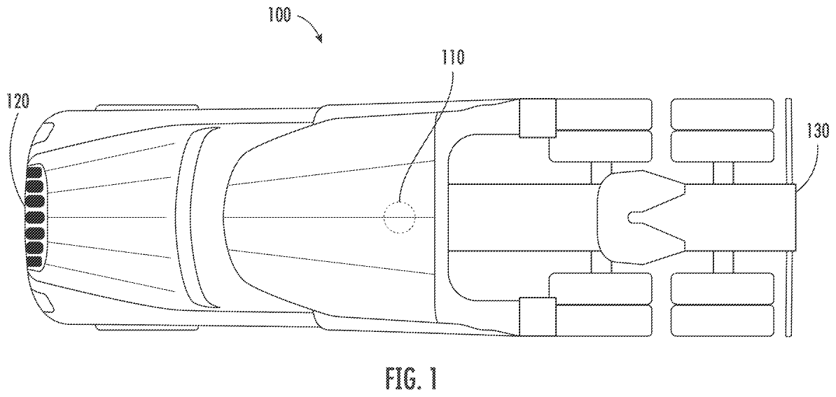

FIG. 1 illustrates a truck 100 for which embodiments described herein may be particularly beneficial. While embodiments of the system, method, and apparatus for mitigating vibrations at a sensor within a vehicle can be employed in any vehicle, the vibrations found in commercial trucks are generally substantial such that the embodiments of the present disclosure are well-suited to such vehicles. The truck 100 depicted in FIG. 1 includes a central location 110 that is approximately midway between the front 120 of the truck and the back 130 of the truck. This central location may be a good location for a localization sensor or sensor array for establishing an accurate location of the truck within an environment.

While a central location of a vehicle may be well-suited for a localization sensor or sensor array, other locations can be employed. Further, if a localization sensor is disposed away from the central location, the distance between the localization sensor and the central location of the vehicle can be established as an offset, such that even sensors not located within a central location of a vehicle can readily identify a location of the central location of the vehicle through application of the offset to the localized position of the localization sensor.

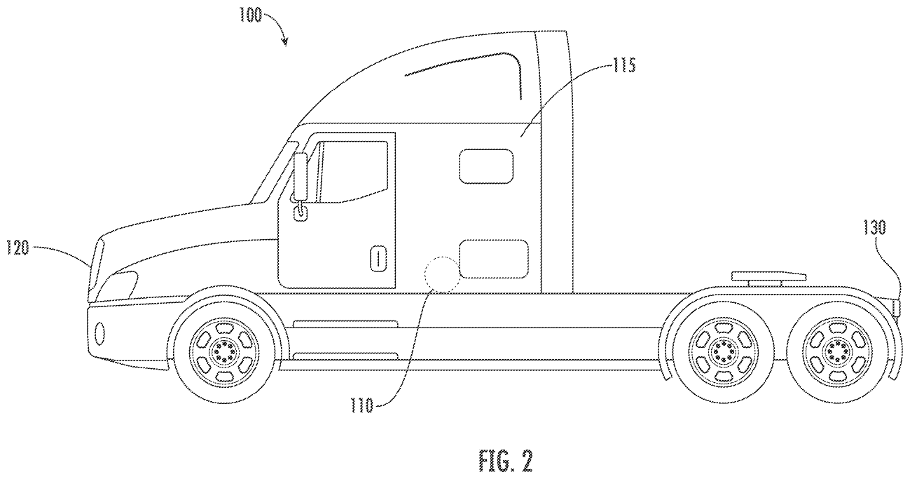

The localization sensor or sensor array of an example embodiment may be protected from the elements and from an environment of the truck 100 by placing the localization sensor or sensor array within the vehicle. FIG. 2 illustrates a left-side view of the truck 100 of FIG. 1 illustrating a relative position of a localization sensor at the central location 110. This location is within the cab 115 of the truck 100, such that the localization sensor is protected from environmental concerns such as temperature, humidity, water, etc. Further, the location enables efficient maintenance. As noted above, sensors can be placed in a variety of locations on a vehicle, and the illustrated central position of FIGS. 1 and 2 is merely an example location.

The central location of the localization sensor of the truck 100 in FIGS. 1 and 2, while providing a convenient and logical relative position within the vehicle, also includes some challenges. The location within the cab 115 of the truck 100 is subject to vibrations from a variety of sources. The cab 115 may have some degree of vibration damping relative to the road surface and to the engine of the truck. This may be in the form of a pneumatic suspension between a frame of the truck and the cab. However, vibrations still exist within the cab as any isolation of the cab from the frame of the truck cannot be overly compliant while still maintaining a safe and secure environment for an occupant.

Vibrations within the cab 115 of the truck 100 may particularly be present in a low frequency range (e.g., below about 50 Hz). This vibration is largely from powertrain components, such as the engine and the large reciprocating mass therein. Further, in conventional internal combustion engine vehicles, the combustion events and exhaust produce substantial vibrations, along with compression release engine braking, otherwise known as a Jacobs Brake or Jake Brake. Compression release engine braking, when activated, opens exhaust valves to the engine cylinders before the compression stroke ends, releasing compressed gas from within the combustion chambers which slows the vehicle provided the vehicle is in gear (i.e., not in neutral). While such braking is effective, it also generally produces loud, low frequency noises and vibrations. These additional vibrations can be experienced in the cab 115 of the truck 100 and can adversely affect the sensor accuracy or a localization sensor mounted in the cab.

Localization sensors such as IMUs can be adversely impacted by vibrations, particularly low-frequency vibrations that generally result in larger motions at lower frequencies. These vibrations can create noise that drowns out actual signal data output from an IMU to a unit or controller that interprets the IMU sensor data. A noisy signal can be difficult or impossible to process accurately, such that the IMU functionality is harmed by the low frequency vibrations.

The floor of a cab 115 of a truck 100 is subject to such low-frequency vibrations, such that in order to improve the efficiency and effectiveness of a localization sensor mounted to a floor of the cab of the truck, the localization sensor needs to be isolated from these vibrations, and the vibrations mitigated to reduce or eliminate noise at the localization sensor.

As described above, a localization sensor or sensor array can be adversely impacted by vibrations experienced at the sensor or sensor array. IMUs are particularly vulnerable to such vibrations. IMUs measure forces, angles, rates of change of forces and angles, and orientation. These measurements are based on devices within the IMU that may include accelerometers, gyroscopes, and magnetometers. An IMU including a magnetometer is sometimes referred to as an “IMMU” or an inertial and magnetic measurement unit; however, the abbreviation IMU and general term for localization sensors as described herein encompass what is otherwise known as an IMMU.

IMUs operate by measuring linear acceleration using accelerometers and measuring rotational rate using one or more gyroscopes. A magnetometer can be used to help identify a heading and orientation of an IMU. IMUs can include accelerometers, gyroscopes, and magnetometers for each of three orthogonal axes. IMUs can be used in conjunction with other localization techniques, such as GPS, to more accurately identify a location of a vehicle through dead reckoning and establishing movement relative to known ground truth locations. An IMU can include a controller configured to interpret the signals from the various components of the IMU. Optionally, the IMU can provide raw sensor data to a separate controller for the controller to interpret.

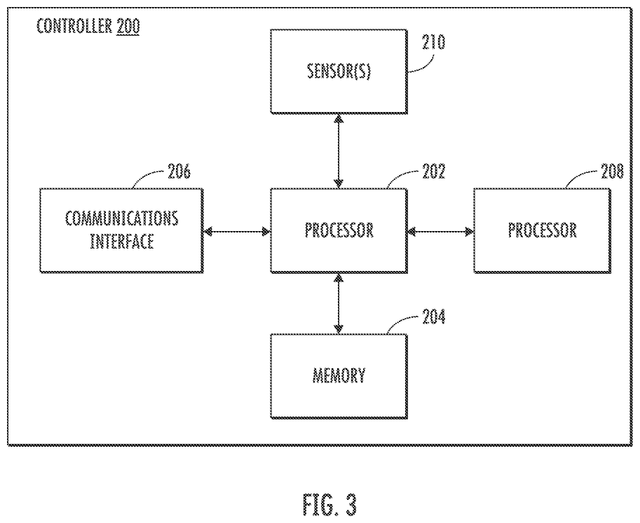

FIG. 3 is a schematic diagram of an example of a controller 200 that may be implemented to provide sense and interpret signals from the various sensors of an IMU, or implemented more generally as a localization sensor. The controller 200 may include or otherwise be in communication with a processor 202, a memory device 204, a communications module 206 and a sensor(s) 210. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 202 (and/or co-processors or any other processing circuitry assisting or otherwise associated with the processor) may be in communication with the memory device 204 via a bus for passing information among components of the apparatus. The memory device 204 may include, for example, one or more volatile and/or non-volatile memories. In other words, for example, the memory device 204 may be an electronic storage device (e.g., a computer readable storage medium) comprising gates configured to store data (e.g., bits) that may be retrievable by a machine (e.g., a computing device like the processor). For example, the memory device 204 could be configured to buffer input data for processing by the processor 202. Additionally or alternatively, the memory device could be configured to store instructions for execution by the processor.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. The processor may be embodied as a microcontroller having custom bootloader protection for the firmware from malicious modification in addition to allowing for potential firmware updates.

In an example embodiment, the processor 202 may be configured to execute instructions stored in the memory device 204 or otherwise accessible to the processor 202. Alternatively or additionally, the processor 202 may be configured to execute hard coded functionality. As such, whether configured by hardware or software methods, or by a combination thereof, the processor 202 may represent an entity (e.g., physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device (e.g., a vehicle control module) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. In one embodiment, the processor 202 may also include user interface circuitry configured to control at least some functions of one or more elements of the localization sensor or IMU described herein.

The communications module 206 may include various components, such as a device or circuitry embodied in either hardware or a combination of hardware and software that is configured to receive and/or transmit data for communicating data between a localization sensor and vehicle controller as described herein. In this regard, the communications module 206 may include, for example, an antenna (or multiple antennas) and supporting hardware and/or software for enabling communications wirelessly. Additionally or alternatively, the communications module 206 may be configured to communicate via wired communication with other components of a vehicle or a computing device as described herein.

The sensor(s) 208 may be in communication with the processor 202 to receive an indication of movement, orientation, rate of change of movement or orientation, or the like. The sensor(s) 208 may also be in communication with the memory device 204 and/or the communications module 206, such as via a bus. The controller 200, as described herein, can process the IMU sensor data together with other localization information (e.g., GPS) to accurately localize the vehicle.

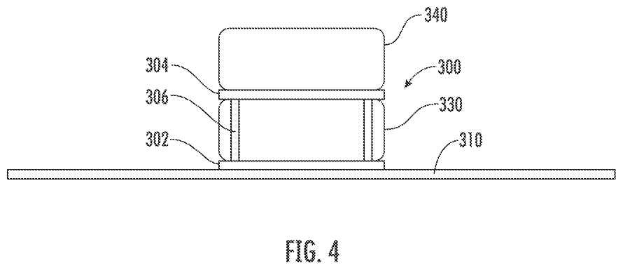

As the localization of a vehicle is of critical importance for autonomous vehicle control, the localization sensor or sensor array described herein may include a redundant or back up localization sensor or array. This may be in the form of a second IMU, for example. FIG. 4 illustrates an example embodiment of a localization system including localization sensors. As shown, a bracket 300 is mounted to a sheet metal structure 310 of the vehicle. This may be, for example, a floor of a cab of a truck. The bracket 300 shown in FIG. 4 supports a first localization sensor 330 and a second localization sensor 340. The first localization sensor 330 and the second localization sensor 340 may be the same type of sensors or may be different. In one example embodiment, the first localization sensor 330 and the second localization 340 sensor are both IMUs. Alternatively, the first localization sensor 330 may be an IMU, while the second localization sensor 340 may include a GPS sensor. According to an example embodiment, the first localization sensor 330 is secured to the bracket 300 using at least one fastener. The fastener may include a threaded fastener, rivet, clamp, or the like to mechanically couple the first localization sensor 330 to the bracket 300.

The bracket 300 of the illustrated embodiment includes support for both the first localizations sensor 330 and the second localization sensor 340. The bracket 300 includes a first plate 302 to which the first localization 330 sensor is secured, such as by fasteners (not shown). The bracket further includes a second plate 304 to which the second localization sensor 340 is secured, such as by at least one fastener (not shown). As the first sensor and the second sensor are both for purposes of localization, their position within the vehicle is known, and the center of the vehicle is a desirable location for such sensors. Further, in an instance in which the second localization sensor 340 is configured to be a redundant sensor for back up purposes, having the same location and position as the first localization sensor is most suitable. The position of the sensors, using latitude and longitude, is most critical when navigating an environment, while the “z-axis” otherwise referred to as altitude, height, or elevation, is of a lower degree of criticality. As such, the first localization sensor 330 and the second localization sensor 340 may be vertically stacked to achieve the closest possible redundancy between the two sensors. As such, the bracket 300 of example embodiments described herein may support the second plate 304 above the first plate 302 in a vertically stacked arrangement through use of one or more supports 306 to elevate the second plate 304 relative to the first plate 302. This arrangement allows alignment and comparison between the latitude and longitude measurements from both the first localization sensor 330 and the second localization sensor 340 without requiring an offset calculation.

The bracket 300 secured to the sheet metal structure 310 of the vehicle may be attached by fasteners, such as bolts received into the bracket 300 through the sheet metal structure 310. These bolts may hold the bracket securely to the sheet metal structure. The sheet metal used in the construction of vehicles is generally relatively thin, such as on the order of several thousandths of an inch. Sheet metal for some components may be on the order of 18-gauge or about 0.0478 inches thick, while other components may be as thin as 24-gauge or 0.0239 inches thick. Metal panels formed of sheet metal may require some degree of stiffening to help avoid bending and to help mitigate harmonic vibrations in the panel. To accomplish this, raised (or recessed) elements may be formed in the sheet metal to provide structural rigidity. These raised elements change the profile of the sheet metal and provide bends and reliefs that improve structural rigidity and help the sheet metal panel retain its shape under load. The sheet metal structure of a vehicle described herein generally includes a horizontal component o the vehicle, where the sheet metal structure 310 includes a first major surface to which the bracket 300 is shown to be attached in FIG. 4, and a second major surface opposite the first major surface.

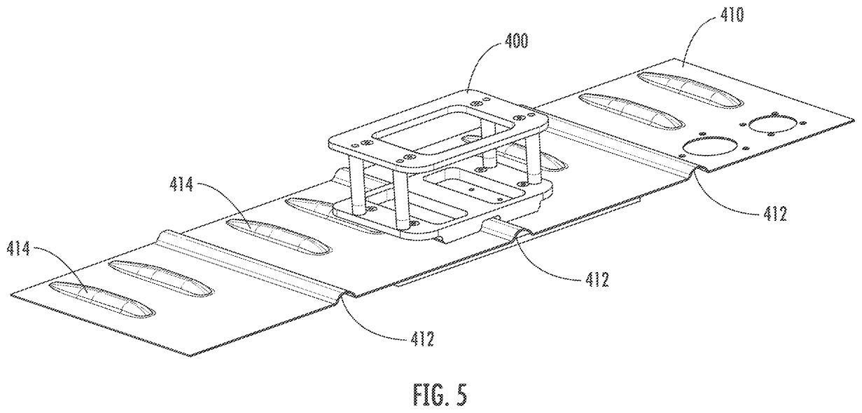

FIG. 5 illustrates an example embodiment of the sheet metal structure 410 of a vehicle with a bracket 400 attached thereto. The sheet metal structure depicted includes bends in the form of ribs 412 that extend along the sheet metal structure 410. These longitudinally extending ribs 412 resist bending in a direction perpendicular to the longitudinal extend of the ribs. The sheet metal structure 410 further includes raised bends 414 formed into the sheet metal structure. These raised bends 414 render the sheet metal structure 410 more resistant to vibration as they disrupt the flat expanse of the sheet metal structure 410 panel.

While the sheet metal of a vehicle may include elements that attempt to mitigate and reduce vibrations, there is typically some degree of vibration still experienced by the sheet metal. This is particularly true for low frequency vibrations (e.g., below 50 Hz). Attaching the localization sensor(s) to structurally rigid elements of a vehicle, such as frame rails, may not be feasible such that attachment to sheet metal is necessary. This renders the localization sensor(s) vulnerable to vibrations experienced at the sheet metal. The sheet metal can include the features described above to help mitigate vibrations experienced at the location where the localization sensor(s) are mounted; however, these features may not sufficiently reduce or eliminate vibrations at the point where the localization sensor(s) are mounted.

Conventional vibration reduction techniques involve dampening vibration through use of compliant elements, such as rubber bushings. Rubber bushings and conventional damping methods may suitably dampen mid-frequency and high-frequency vibrations (e.g., 500 Hz or more). However, such compliant elements are insufficient at damping the low frequency vibrations experienced in a vehicle through sheet metal resonance. Frequencies on the order of 100 Hz and lower may not be suitably damped by rubber bushings or shock absorbers. Further, these frequencies experience harmonics that complicate the damping process. Rather than using compliant elements for damping vibration, Applicant has developed a system for mitigating low frequency vibrations for the localization sensor(s) of a vehicle, particularly when mounted to a sheet metal structure.

As noted above, localization sensors can be sensitive to vibrations and the vibrations can reduce the efficiency and accuracy of data generated by localization sensors. Because of the types of sensors used in an IMU, vibratory noise is particularly problematic to the functionality of an IMU.

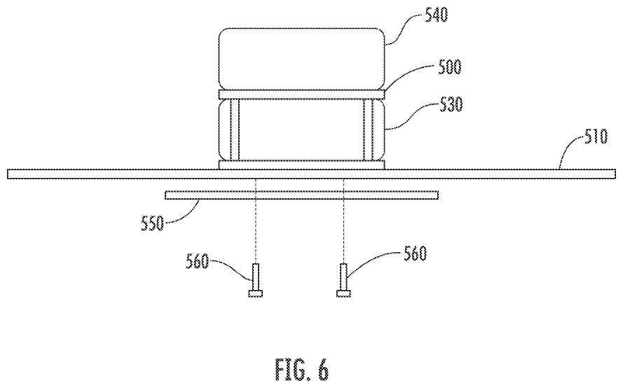

Embodiments of the present disclosure employ a backing plate to further stiffen the sheet metal of a vehicle to mitigate low frequency vibrations. FIG. 6 illustrates an example embodiment in which a bracket 500 is mounted to a sheet metal structure 510 of a vehicle. A first localization sensor 530 and a second localization sensor 540 are mounted to the bracket, such as using threaded fasteners. This connection rigidly attaches the first localization sensor 530 and the second localization sensor 540 to the sheet metal structure 510 of the vehicle. A backing plate 550 is mounted to the sheet metal structure 510 on a side of the sheet metal structure opposite to that of the bracket 500. The backing plate 550 can be secured through the sheet metal structure 510 to the bracket 500, such as using threaded fasteners 560, effectively clamping the sheet metal structure between the bracket and the backing plate.

The backing plate of an example embodiment is formed of a rigid material, such as aluminum, and may be substantially thicker than the sheet metal thickness. For example, the backing plate may be on the order of 0.25 inches thick. While many materials may be employed for such a backing plate, such as many metals, aluminum and magnesium and alloys thereof may be well-suited for use as the backing plate due to their strength-to-weight ratios.

The efficiency of vehicles, whether it is measured in fuel efficiency (e.g., miles-per-gallon), electrical efficiency (e.g., mile-per-kilowatt-hour), or a combination thereof, is important from both the standpoint of cost and emissions. One way in which efficiency can be improved is through weight reduction of a vehicle. As such, embodiments described herein are sized and shaped according to the dimensions necessary to mitigate vibration, but not to add unnecessary weight. Further, the backing plate can employ weight reduction techniques to further reduce any weight added by the backing plate. For example, the backing plate may include holes, recesses, or other voids that can reduce weight while not sacrificing rigidity of the backing plate.

As sheet metal is vulnerable to bending, the backing plate may not make flush contact with the sheet metal along the entire surface of the backing plate. According to some embodiments, a material may be used between the backing plate 550 and the sheet metal structure 510. This material may be a compliant material that enables improved surface contact to account for any irregularities or differences between the sheet metal structure 510 and the backing plate 550. Material may include a rubber, plastic (e.g., high density polyethylene), foam, or the like. Optionally, a lubricant may be used in lieu of or in addition to any of the materials between the backing plate 550 and the sheet metal structure 510. A lubricant may be employed for noise reduction and to avoid any potential squeaks or rattles.

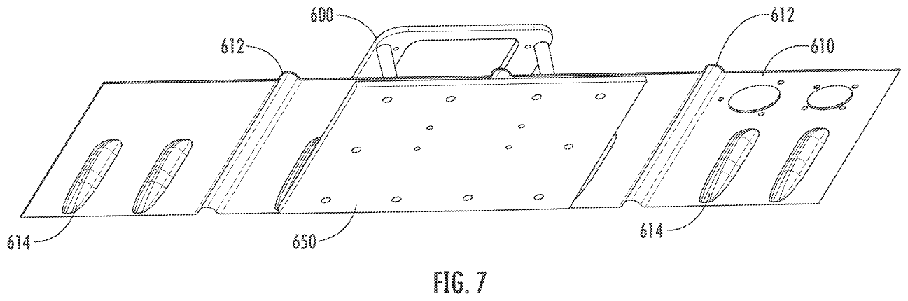

FIG. 7 illustrates another example embodiment of a bracket 600 configured to receive at least one localization sensor (not shown), a backing plate 650, and a sheet metal structure 610 disposed between he bracket and the backing plate. Also illustrated in FIG. 7 are the ribs 612 and raised bends 614 positioned to add structural rigidity to the sheet metal structure 610.

The backing plate described with respect to the embodiments above provides a substantially rigid backing to a relatively less rigid sheet metal structure of a vehicle, thereby improving the rigidity of the sheet metal structure. While a single plate disposed on an opposite side of the sheet metal structure from a sensor bracket is depicted in the above-described embodiments, further embodiments described herein can employ additional configurations. One such configuration is a backing plate mounted between the sheet metal structure and the bracket. In such an embodiment, the sheet metal structure is not sandwiched between the bracket and the backing plate, such that the stiffening effect on the sheet metal structure can be achieved through a different mechanism. One such mechanism is the addition of fasteners that secure the backing plate on top of the sheet metal structure. The addition of fasteners at spaced locations along the backing plate secure the sheet metal structure to the backing plate along a plane of the backing plate, thereby improving the stiffness of the sheet metal structure. In such an embodiment, the backing plate may be of similar construction (e.g., size and thickness) as one that would be disposed on an opposite side of the sheet metal structure relative to the bracket.

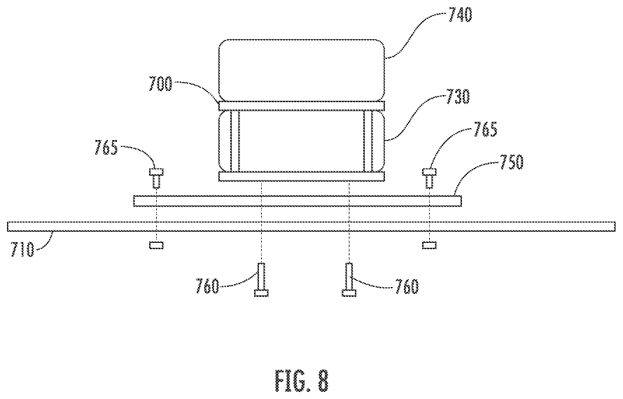

FIG. 8 illustrates an example embodiment as described above where the backing plate 750 is disposed on the same side of the sheet metal structure 710 as the bracket 700 which holds the first localization sensor 730 and the second localization sensor 740. As shown, the bracket 700 is secured to the sheet metal structure 710 by fasteners 760, while securing therebetween the backing plate 750. This arrangement securely affixes the backing plate 750 between the bracket 700 and the sheet metal structure 710. However, the fasteners 760 that secure the sheet metal structure 710 to the bracket 700 only serve to stiffen the sheet metal structure significantly within the area of the bracket 700 based on the fastener location. The fasteners 760 can further include washers having substantial thickness to further increase the stiffening effect of securing the sheet metal structure 710 to the bracket 700 and the backing plate 750. To further enhance the stiffness of the sheet metal structure 710 provided by the backing plate 750, additional fasteners 765 are provided to secure the areas of the sheet metal structure to the backing plate that are outside of the structure of the bracket. This fastener arrangement allows a greater area of the sheet metal structure 710 to engage the backing plate 750 to provide greater stiffening of the area.

According to another example embodiment described herein, a pair of backing plates can be employed to improve a stiffness of the sheet metal structure. According to such an embodiment, a first backing plate can be disposed between the localization sensor bracket and the sheet metal structure, while a second backing plate can be disposed on a side of the sheet metal structure opposite that of the first backing plate. The first backing plate and the second backing plate can be secured to one another using a plurality of fasteners. Such sandwiching of the sheet metal structure can provide added stiffness to the sheet metal structure and help reduce vibrations experienced at the localization sensor. According to embodiments employing two backing plates, the thickness of the backing plates may be less than that of a single backing plate embodiment, as the stiffness of a pair of backing plates that are secured together by a plurality of fasteners is greater than the stiffness of a single backing plate of the same thickness.

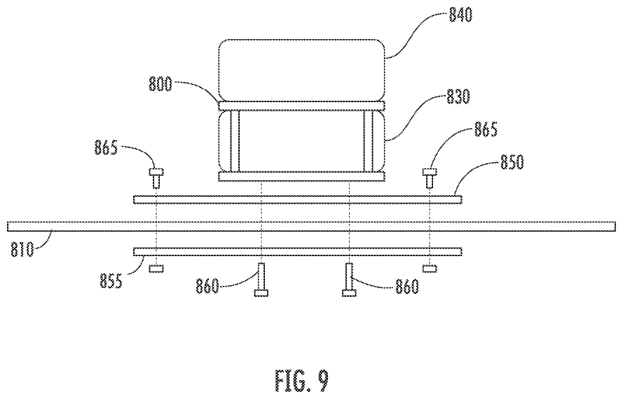

FIG. 9 illustrates an embodiment in which two backing plates are employed to provide additional stiffness and vibration reduction to the localization sensors. As shown, a bracket 800 supports a first localization sensor 830 and a second localization sensor 840. The bracket 800 is secured to the sheet metal structure 810 by fasteners 860. The fasteners also secure a first backing plate 850 and a second backing plate 855 to the bracket 800 and sheet metal structure 810 on either side of the sheet metal structure. This process sandwiches the sheet metal structure 810 between the first backing plate 850 and the second backing plate 855, thereby clamping the sheet metal structure and enhancing the stiffness of the sheet metal structure. The first backing plate 850 and the second backing plate 855 may be of a thinner material than embodiments employing a single backing plate as the coupling of the two backing plates provides enhanced rigidity. To further enhance the stiffness of an embodiment employing two backing plates as shown in FIG. 9, additional fasteners 865 may be used to clamp together the first backing plate 850 and the second backing plate 855 closer to a perimeter of the backing plates to capitalize on a size of the backing plates, and to maximize the stiffness provided by the pair of backing plates.

Embodiments provided herein include a process for manufacturing the bracket and the backing plate(s) described above. The manufacturing process can include cutting one or more members of the bracket and/or the backing plate from a metal plate, such as using plasma cutting, water jet, CNC-machining, etc. The bracket and/or the backing plate(s) can be further machined using CNC-machining to form the fastener holes (including threaded holes) and to remove any unnecessary material to reduce weight. Optionally, the bracket and/or the backing plate(s) can be formed through casting and machining using conventional casting processes for metal. The bracket may be formed of a single piece of metal, such as machined from billet or cast into form and possibly refined using machining. Alternatively, the bracket can be made from several pieces that are fastened together or welded.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A system for vibration mitigation at a sensor comprising:
a bracket configured to support at least one sensor;
a sheet metal structure having a first major surface along which the sheet metal structure extends, and a second major surface opposite the first major surface; and
a backing plate, wherein the bracket is disposed adjacent to the first major surface of the sheet metal structure, wherein the backing plate is disposed adjacent to the second major surface of the sheet metal structure, and wherein two or more fasteners secure the backing plate to the bracket through the sheet metal structure.

2. The system of claim 1, wherein the at least one sensor is secured to the bracket using at least one fastener.

3. The system of claim 1, wherein the sheet metal structure comprises a sheet metal component of a vehicle.

4. The system of claim 3, wherein the at least one sensor comprises a localization sensor.

5. The system of claim 4, wherein the localization sensor comprises an inertial measurement unit (IMU).

6. The system of claim 5, wherein vibrations experienced by the vehicle are dampened by the backing plate before reaching the inertial measurement unit.

7. The system of claim 1, wherein the backing plate is made of aluminum.

8. The system of claim 7, wherein the backing plate is greater than 0.125 inches in thickness.

9. The system of claim 1, wherein the at least one sensor comprises two localization sensors, wherein the two localization sensors comprise two inertial measurement units.

10. The system of claim 9, wherein the bracket comprises a first plate supporting a first of the two inertial measurement units and a second plate supporting a second of the two inertial measurement units.

11. The system of claim 10, wherein the second plate is disposed above the first plate relative to the sheet metal structure, and wherein the second plate is supported above the first plate by at least two supports of the bracket.

12. A method of mitigating vibration at a sensor comprising:
mounting at least one sensor on a bracket;
positioning the bracket on a first side of a sheet metal structure;
positioning a backing plate on a second side of the sheet metal structure; and
securing the backing plate to the bracket using two or more fasteners through the sheet metal structure to clamp the sheet metal structure between the bracket and the backing plate.

13. The method of claim 12, wherein the at least one sensor comprises a first localization sensor and a second localization sensor, wherein the bracket supports the second localization sensor vertically above the first localization sensor relative to the sheet metal structure.

14. A vibration mitigation system for a vehicle comprising:
at least one sensor;
a bracket configured to support the at least one sensor;
a backing plate; and
two or more fasteners,
wherein the bracket is configured to be positioned on a first side of a sheet metal structure of the vehicle, wherein the backing plate is configured to be positioned on a second side of the sheet metal structure of the vehicle, opposite the first side, and wherein the two or more fasteners are configured to secure the backing plate to the bracket through the sheet metal structure.

15. The vibration mitigation system of claim 14, wherein the sheet metal structure of the vehicle is a horizontal sheet metal structure.

16. The vibration mitigation system of claim 15, wherein the at least one sensor comprises a first localization sensor and a second localization sensor.

17. The vibration mitigation system of claim 16, wherein the bracket is configured to support the second localization sensor vertically above the first localization sensor.

18. The vibration mitigation system of claim 17, wherein the first localization sensor is supported by a first plate, wherein the second localization sensor is supported by a second plate, and wherein the second plate is elevated above the first plate by two or more supports.

19. The vibration mitigation system of claim 14, further comprising a noise reducing material positioned between the backing plate and the sheet metal structure.

20. The vibration mitigation system of claim 19, further comprising a noise reducing material positioned between the bracket and the sheet metal structure.
